(19) United States
(12) Patent Application Publication
(10) Pub. No.: US 2005/0252012 A1
(43) Pub. Date: Nov. 17, 2005

(54) Manual saw guard retracting apparatus

(76) Inventor: Charles E. Johnson III, Fullerton, CA (US)

Correspondence Address: Joseph R. Cruse, Suite 1760, 301 E. Ocean Blvd., Long Beach, CA, 90802, US

(21) Appl. No.: 10/843,601

(22) Filed: May 11, 2004

(51) Int. Cl. B27B 9/00

(52) U.S. Cl. 30/391; 30/390

(57) ABSTRACT

A manual retracting device for the movable lower saw guard of a electrical circular saw in which the guard is moved up into its cutting position by depressing a thumb button located adjacent the saw handle permitting the operator to control the movable lower saw guard while continuing to hold and control the power saw at the handle. The guard is automatically returned to its closed protective position when the operator removes his thumb from the control button.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of the Invention

This invention relates to saw safety guard devices, and more specifically pertains to a new manual safety guard apparatus for manually moving a safety guard on a conventional power saw enabling the operator to clearly view the object being cut and ensuring the safety guard will be replaced once the operator removes himself from the apparatus.

2. Background of the Invention

Conventional power saws commonly are equipped with a fixed upper safety guard and a movable lower safety guard for protecting the operator from the saw blade. For safety reasons, this lower safety guard is in an engaged position until the object being cut by the saw passes under the guard and moves it out of the way.

Prior to opening, the guard obstructs the operator's view of the path to be cut on the object. This obstruction requires the operator to look to the open side of the saw and view the line to be cut, placing the operator into a more dangerous position as his eyes and face are no longer protected by the fixed upper safety guard.

In order to remedy this situation the operator will move the lower safety guard manually out of the way by placing the hand that is not holding the main saw handle, directly on the lower guard and moving out it of the way. This is extremely dangerous, in that the lower guard is located in extremely close proximity to the moving saw blade, placing the operator's fingers, thumb and hand in great peril. Also, by using the other hand to manually move the lower guard out of position, the operator looses control over the object that he is cutting, risking additional harm should the object shift or move.

Another common remedy to this situation is for the operator to use another object to wedge and keep the lower guard open until he has finished his work. While performing this manner of moving the lower saw guard out of the way, many times the operator will leave the lower guard wedged open after the operator has finished cutting the object and/or places the saw down, with the sharp cutting blade exposed.

This situation of forgetting to remove a wedge or otherwise return the lower safety guard to its original protected position is dangerous and common. It is so dangerous, it has been called to the attention of many state construction site inspectors. It is such a common practice, it has resulted in millions of dollars of fines over the years.

### BACKGROUND OF THE INVENTION—OBJECTS AND ADVANTAGES

Accordingly, besides the objects and advantages of the saw safety guards described herein, several objects and advantages of the present invention are:
(a) to provide a power saw safety apparatus that will enable the operator's face and eyes to remain protected by the fixed upper safety saw guard by allowing the operator to move the lower safety guard out of the way to better view the cutting line that is obstructed by the lower safety guard when it is engaged;
(b) to provide a power saw safety apparatus that will enable the operator to manually lift the lower movable safety guard of the saw out of the way using the same hand that is holding the power saw, enabling the operator to continue to hold the object being cut:
(c) to provide a power saw safety apparatus that will enable the operator to manually lift the lower movable safety guard of the saw out of the way, while continuing to keep his hands, finger and/or thumb protected above the saw's fixed upper safety guard;
(d) to provide a power saw safety apparatus that will re-engage the lower safety guard immediately when the operator removes his thumb from the button; and
(e) to provide a power saw safety apparatus that will re-engage the lower safety guard immediately when the operator removes himself from the power saw, ensuring that the saw blade will be safely covered when the operator sets the saw down, further ensuring that the operator will be in compliance with safety regulations as they relate to power saws and safety guards on most construction sites; and
(f) to provide a power saw safety apparatus that is light, inexpensive, uncomplicated and easy to operate for both right and left-handed operators.

Further objects and advantages are to provide a closure and re-engagement of the lower safety guard apparatus which can be used for ensured safety and additional compliance with safety regulations. Still further objects and advantages will become apparent from a consideration of the ensuing description and drawing.

### SUMMARY

In accordance with the present invention a safety guard apparatus comprises a manual driver and a cable attached to a movable lower safety guard on a conventional power saw.

### DRAWINGS—FIGURES

In the drawings, closely related figures have the same number but different alphabetic suffixes.

FIG. 1A shows a top view of a conventional power saw equipped with a manual safety guard apparatus for manually moving a lower movable safety guard.

FIG. 1B shows a side view of a conventional power saw equipped with a manual safety guard apparatus for manually moving a lower movable safety guard.

FIG. 2 shows a rear view of the Top Mount Plate FIG. 3 shows a side view of the Cable Mount Pulley

FIG. 4A shows a top view of a conventional power saw equipped with a manual safety guard apparatus for manually moving a lower movable safety guard, the attachment to the lower safety guard on the inside portion of the housing and saw blade.

FIG. 4B shows a side view of a conventional power saw equipped with a manual safety guard apparatus for manually moving a lower movable safety guard, the attachment to the lower safety guard on the inside portion of the housing and saw blade.

FIG. 5 shows a top view of a conventional power saw equipped with a manual safety guard apparatus with a rigidly flexible housing and driver for manually moving a lower movable safety guard and capable of being placed on either side of the power saw handle.

### DRAWINGS—REFERENCE NUMERALS

11 Cable
12 Driver Housing
13 Cable Attachments
14 Cable Mount Pulley
15 Housing Attachments
16 Top Mount Plate
17 Driver
18 Driver End Button

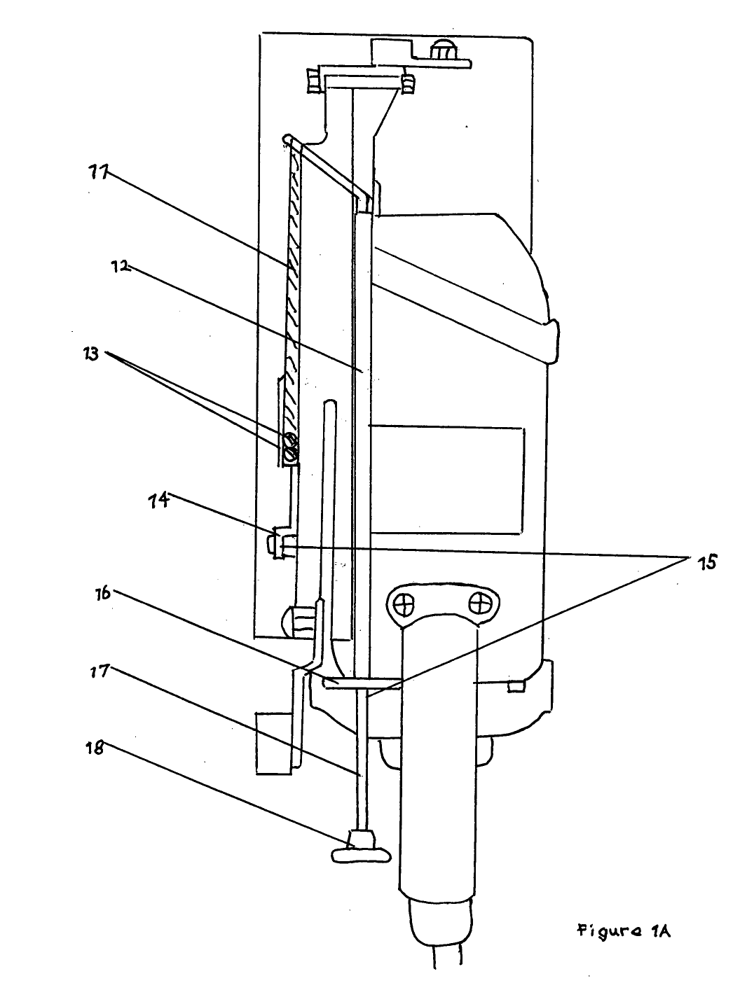

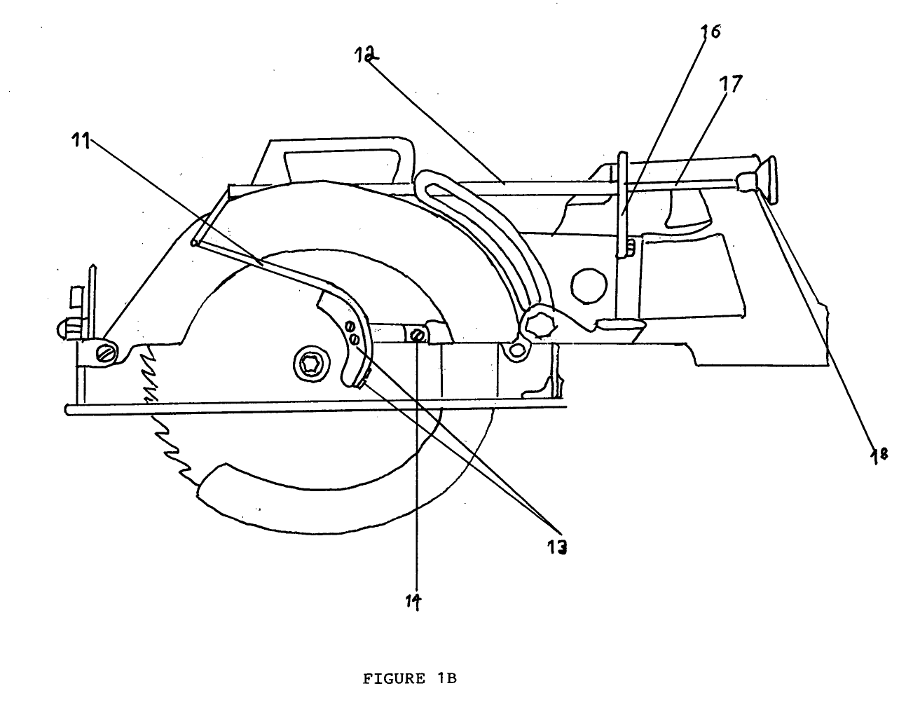

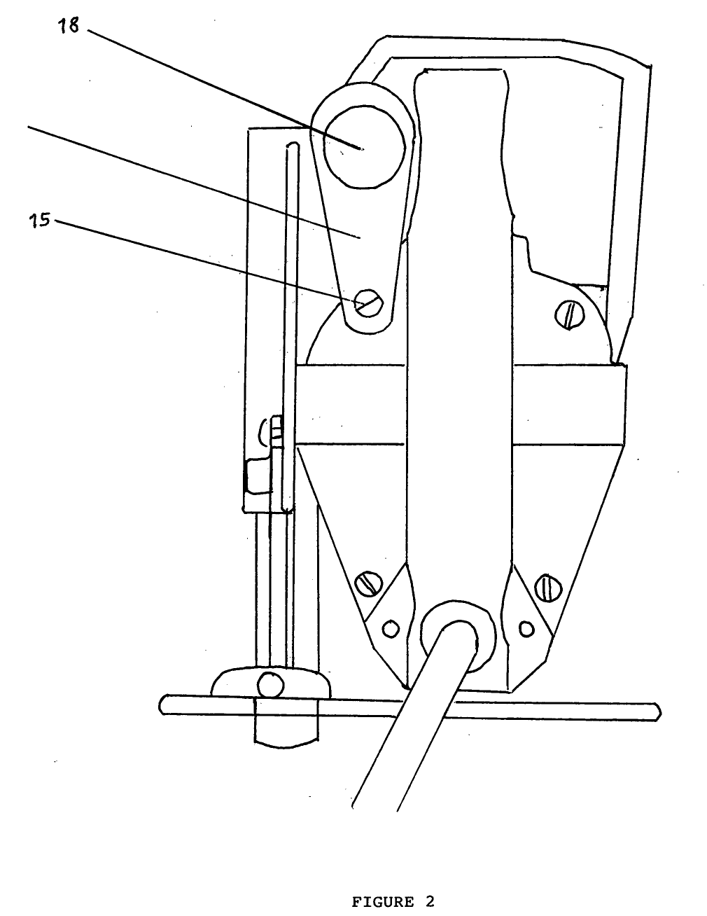

### DETAILED DESCRIPTION—FIGS. 1A, 1B, 2, 3—PREFERRED EMBODIMENT

A preferred embodiment of the apparatus of the present invention is illustrated in FIG. 1A (top view) and FIG. 1B (side view). The apparatus has a rigid driver (17) consisting of a rigid material that can move forward and back through a fixed housing (11) without fracturing. The fixed housing (11) is attached to a Top Mount Plate (16) by a rigid attachment means, such as a weld, rivet, screw or bolt, etc. . . .

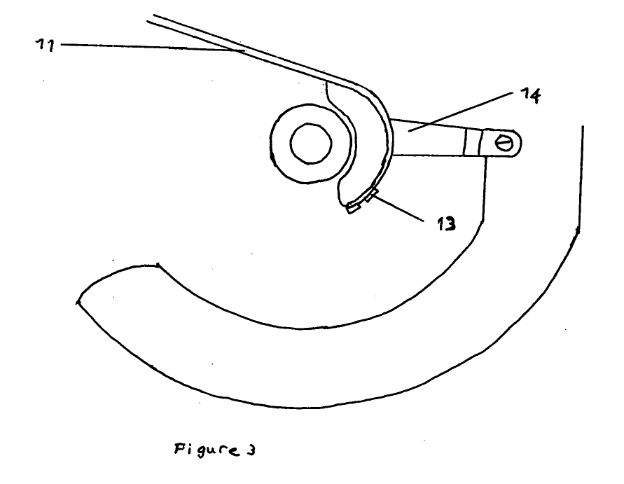

The Top Mount Plate (16) is attached to the conventional power saw by a rigid attachment means, such as a rivet, screw or bolt, etc. . . . In a preferred embodiment that Top Mount Plate (16) is attached to the conventional power saw through attachment means currently utilized by the saw manufacturer as illustrated in FIG. 2.

At one end of the driver (17), a button (18) is placed for enhanced control and comfort of the operator. The preferred embodiment of the button (18) is concave, but can also be flat.

On the opposite end of the driver (17), is attached a flexible cable (11), attached by Cable attachments (13). In the preferred embodiment, the Cable attachments (13) are rivets, but can be any type of attachment parts that attach material together, such as screws or bolts.

In the preferred embodiment, the flexible cable (11) is a flexible plastic, however can consist of any other flexible material that can be repeatedly bent without fracturing, such as polyethylene, polypropylene, vinyl, nylon, rubber, leather, various plasticized materials, steel cable, etc. . . .

At the opposite end of the flexible cable is a Cable Mount Pulley (14) which is connected to the Cable (11) by Cable Attachments (13) as illustrated in FIG. 3. The Cable Mount Pulley connects to the Power Saw's movable lower safety guard, by removing the bolt on the screw holding the lower safety guard thumb lever, inserting the Cable Mount Pulley (14) onto the screw, replacing the saw's lower guard thumb lever.

In the preferred embodiment, the Cable Mount Pulley (14) is attached to the movable lower safety by an attachment mechanism, which can be in the form of a rivet, screw or bolt or other similar attachment mechanism.

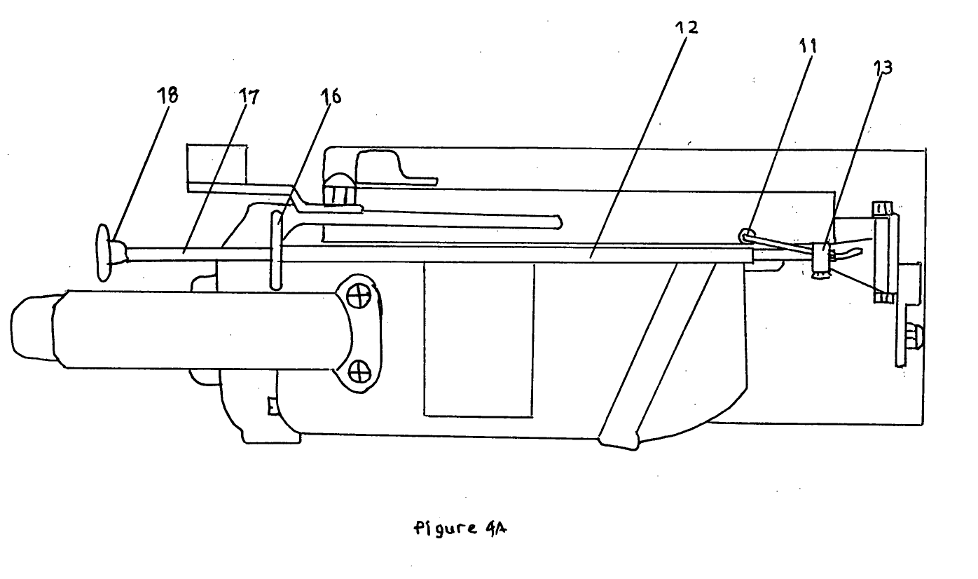

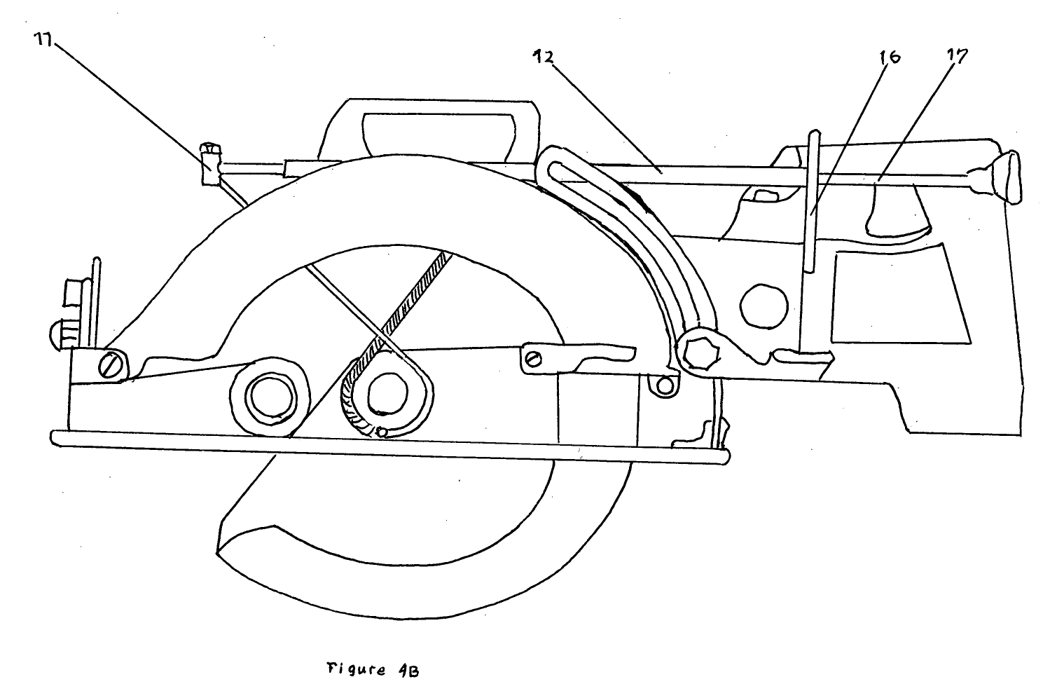

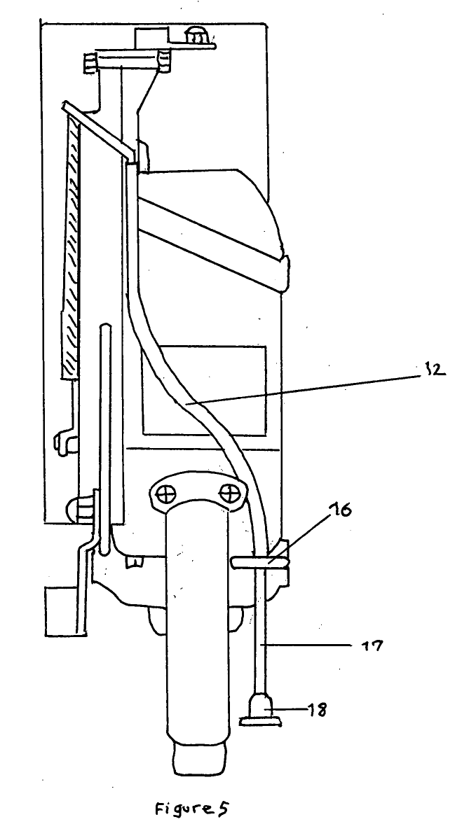

FIGS. 4A, 4B, 5—Additional Embodiments

There are various possibilities with regard to the manual safety guard apparatus for manually moving the lower movable safety guard, as illustrated in FIGS. 4A and 4B, which presents views of the attachment to the lower safety guard on the inside portion of the lower movable safety guard. In FIGS. 4A and 4B, the cable is placed behind the power saw blade through a hole or other type of opening in the fixed upper safety guard. The Cable connects to the Power Saw's movable lower safety guard in the opposite direction of the movable lower saw guard's spring by form of a rivet, screw or bolt or other similar attachment mechanism.

Another embodiment of the apparatus of the present invention is illustrated in FIG. 5. The apparatus has a rigidly flexible driver (17) consisting of a rigidly flexible material that can move forward and back through a rigidly flexible housing (11) without fracturing. The housing (11) is attached to a Top Mount Plate (16) by a rigid attachment means, such as a weld, rivet, screw or bolt, etc. . . .

The Top Mount Plate (16) is attached to the conventional power saw by a rigid attachment means, such as a rivet, screw or bolt, etc. . . . In a preferred embodiment that Top Mount Plate (16) is attached to the conventional power saw through attachment means on either side of the power saw handle currently utilized by the saw manufacturer. As illustrated in FIG. 5, this embodiment permits the use of the apparatus for a left handed operator as easily as a right handed operator.

Operation

FIGS. 1A, 1B, 2, and 3 show the manner of using the manual safety guard apparatus for manually moving a movable lower safety guard on a conventional power saw which only requires the operator to depress the Driver End Button (18) forward, so that the Driver (17) passes through the Driver Housing (12), causing the Cable (11) to shift the Cable Mount Pulley (14) to a position that extracts the movable lower safety guard out of the way of the operator's view.

The movable lower safety guard immediately moves back into its original position whenever the operator releases pressure or disengages from the driver end button (18). Therefore, should an operator need to place the lower movable saw guard in an open position while operating a conventional power saw, he will not need to use other hands or use other objects to “wedge” the guard open, as the operator is able to operate the saw and manually move the guard into an open position with one hand. The guard will always be replaced in its originally closed position since there is no longer a need to wedge the lower guard open since it is so easy to operate.

FIGS. 4A and 4B show the Cable (11) placed in an opening of the fixed upper saw guard. The manner of using the manual safety guard apparatus for manually moving a movable lower safety guard on a conventional power saw only requires the operator to depress the Driver End Button (18) forward, so that the Driver (17) passes through the Driver Housing (12), causing the Cable (11) to extract the movable lower safety guard out of the way of the operator's view. The Cable (11) is attached in the opposite direction of the lower safety guard's spring so that the safety guard will rest in its closed safety position when the Driver End Button (18) is no longer depressed.

FIG. 5 shows the manner of using the manual safety guard apparatus for manually moving a movable lower safety guard on a conventional power saw for a left handed operator utilizing the rigidly flexible driver (17) and rigidly flexible driver housing (12).

Advantages.

From the description above, a number of advantages of this manual saw guard retracting apparatus become evident:
(a) The operator's face and eyes will remain protected by the fixed upper safety saw guard as since the operator will be able to move the lower safety guard out of the way to better view the cutting line that is obstructed by the lower safety guard when it is engaged;
(b) The operator will be able to continue to hold the object being cut since the operator will be able to manually lift the lower movable safety guard of the saw out of the way using the same hand that is holding the power saw;
(c) The operator's hands, fingers and/or thumb are continued to be protected above the saw's fixed upper safety guard, since the operator will be able to manually lift the lower movable safety guard out of the way with his hand safely away from the saw blade;
(d) The lower safety guard immediately re-engages when the operator removes or disengages his thumb from the button; and
(e) Ensures that the operator and his employer will be in compliance with safety regulations as they relate to power saws and safety guards on most construction sites as the lower safety guard will immediately re-engage when the operator disengages from the power saw, ensuring that the saw blade will be safely covered when the operator sets the saw down.

### CONCLUSION, RAMIFICATIONS, AND SCOPE

Accordingly, the reader will see that the Manual Saw Guard Retracting Apparatus can be used to move the lower movable safety guard out of the operator's way and return the lower movable saw guard to a safe position as soon as the operator either releases pressure from the driver end button or otherwise disengages from the saw.

In addition, when the movable lower saw guard is returned to its safe position, there is no longer the risk of fines from health and safety agencies regulating construction sites. Furthermore, the Manual Saw Guard Retracting Apparatus has the additional advantages in that:
It permits the operator to better view the cutting line that is normally obstructed by the lower safety guard when it is engaged;
It permits the operator to continue to hold the object being cut while manually lifting the lower movable safety guard of the saw out of the way using the same hand that is holding the power saw, not the object;
It protects the operator's hands, fingers and/or thumb above the saw's fixed upper safety guard;
It immediately re-engages the safety guard when the operator removes or disengages his thumb from the button;
It ensures compliance with most safety regulations as they relate to power saws and safety guards on most construction sites;
It is inexpensive to add to conventional power saws; and
It does not add needless and unnecessary weight allowing both right and left-handed operators to handle the saw with ease.

Although the description above contains many specificities, these should not be construed as limiting the scope of the invention but as merely providing illustrations of some of the presently preferred embodiments of this invention. For example the cable can attach to different positions of the lower saw guard and the button can be placed on either side of the saw handle to permit right and left handed operators to use the device equally.

Thus the scope of the invention should be determined by the appended claims and their legal equivalents, rather than by the examples given.

1. A lower safety saw guard lifting apparatus for manually lifting a lower safety saw guard of a conventional electrical power saw possessing a circular saw blade, comprising:
a lifting means for lifting the lower safety guard of the power saw, the lifting means secured to said saw and mechanically connected to said lower safety guard; and
said lifting means mechanically connected to an activating button of said saw, wherein said lifting means lifts said lower safety guard when the activating button is manually depressed, and wherein said lifting means closes said safety guard when said button is released;
wherein said lifting means comprises:
a rigid open sleeve secured to the fixed housing of said saw, said sleeve having a first end and a second end;
a rigid driver movingly placed inside said sleeve;
said driver having two opposite ends, both said driver ends extending beyond said ends of said sleeve;
one of said driver ends connected to an activating end button;
a cable having opposite ends, one of said ends of said cable secured to said end of said driver opposite said end button;
said opposite end of said cable mechanically connected to a rigid mount pulley;
said mount pulley mechanically connected to said lower safety guard for moving the said lower safety guard between the open and closed positions.

2. The lower safety guard lifting apparatus as in claim 1, in which the sleeve and driver are rigidly flexible.

3. A lower safety saw guard lifting apparatus for manually lifting a lower safety saw guard of a conventional electrical power saw possessing a circular saw blade, comprising:
a lifting means for lifting the lower safety guard of the power saw, the lifting means secured to said saw and mechanically connected to said lower safety guard; and
said lifting means mechanically connected to an activating button of said saw, wherein said lifting means lifts said lower safety guard when the activating button is manually depressed, and wherein said lifting means closes said safety guard when said button is released;
wherein said lifting means comprises:
a rigid open sleeve secured to the fixed housing of said saw, said sleeve having a first end and a second end;
a rigid driver movingly placed inside said sleeve;
said driver having two opposite ends, both said driver ends extending beyond said ends of said sleeve;
one of said driver ends connected to an activating end button;
a cable having opposite ends, one of said ends of said cable secured to said end of said driver opposite said end button;
said cable movingly placed inside said saw housing, wherein said opposite end of said cable mechanically connected said lower safety guard opposite the lower safety guard's spring for moving the said lower safety guard between the open and closed positions.

4. The lower safety guard lifting apparatus as in claim 3 in which the sleeve and driver are rigidly flexible.
